(19) United States
(12) Patent Application Publication
(10) Pub. No.: US 2011/0183190 A1
(43) Pub. Date: Jul. 28, 2011

(54) Case for a secondary battery and manufacturing method thereof

(76) Inventor: Sungkab Kim, Suwon-si (KR)

(21) Appl. No.: 12/805,532

(22) Filed: Aug. 4, 2010

(30) Foreign Application Priority Data
Jan. 26, 2010 (KR) 10-2010-0007039

(51) Int. Cl. H01M 2/02; C25D 5/44

(52) U.S. Cl. 429/163; 205/210

(57) ABSTRACT

A case for a secondary battery and a manufacturing method thereof, the case including a body formed of a conductive material, the body accommodating an electrode assembly; and a crystal barrier type oxide film on a surface of the body.

### BACKGROUND

1. Field

Embodiments relate to a case for a secondary battery and a manufacturing method thereof.

2. Description of the Related Art

Generally, unlike a primary battery incapable of charge, a secondary battery is a chargeable and dischargeable battery, and is widely used in the field of advanced electronic equipment, e.g., portable phones, Personal Digital Assistants (PDA), and notebook computers. Particularly, a, e.g., lithium, ion secondary battery has a driving voltage of 3.6 V, which is three times higher than a nickel-cadmium battery or a nickel-hydrogen battery, which is much used as the power source of electronic equipment. The use of the lithium ion secondary battery is rapidly increasing because an energy density per unit weight is high.

Such a lithium ion secondary battery uses a lithium-based oxide as a positive electrode active material and uses a carbon material as a negative electrode active material. Moreover, the lithium ion secondary battery is manufactured in various types, e.g., a cylinder type battery, a prismatic type battery, and a pouch type battery.

The lithium ion secondary battery may include an electrode assembly and a conductive case accommodating the electrode assembly.

### SUMMARY

Embodiments are directed to a case for a secondary battery and a manufacturing method thereof which represent advances in the art.

It is a feature of an embodiment to provide a case for a secondary battery and a manufacturing method thereof, which can form an oxide film on the surface of the case in a more stable barrier structure having strong corrosion resistance without separately sealing the oxide film.

At least one of the above and other features and advantages may be realized by providing a case for a secondary battery, the case including a body formed of a conductive material, the body accommodating an electrode assembly; and a crystal barrier type oxide film on a surface of the body.

The body may be an aluminum plate including aluminum or an aluminum alloy, and the crystal barrier type oxide film may be a crystal barrier type oxide-aluminum membrane.

The body may be an aluminum plate including aluminum or an aluminum alloy, and the crystal barrier type oxide film may be a crystal barrier type oxide-aluminum membrane which is formed by an amorphous oxide-aluminum membrane on the aluminum plate that has been subjected to a thermal treatment.

In the thermal treatment, a heating temperature may be about 300° C. to about 600° C., and a heating time may be about one hour to about twenty four hours.

The amorphous oxide-aluminum membrane may be formed on a surface of the aluminum plate through an electro-chemical treatment while the aluminum plate is treated with an adipic acid solution.

In the electro-chemical treatment in the adipic acid solution, a concentration of the adipic acid solution may be about 0.5 M to about 1.5 M, a processing temperature may be about 60° C. to about 80° C., and a processing voltage may be about 100 V to about 150 V.

A thickness of the amorphous oxide-aluminum membrane may be increased by an electro-chemical treatment in a boric acid solution for securing further insulating properties of the aluminum plate.

In the electro-chemical treatment in the boric acid solution, a concentration of the boric acid solution may be about 0.5 M to about 2.0 M, a processing temperature may be about 60° C. to about 80° C., and a processing voltage may be about 250 V to about 500 V.

At least one of the above and other features and advantages may also be realized by providing a high-capacity or high-power battery including the case of an embodiment.

At least one of the above and other features and advantages may also be realized by providing a battery for a hybrid electric car or a case of a battery for an electric car including the case of an embodiment.

At least one of the above and other features and advantages may also be realized by providing a method of manufacturing a case for a secondary battery, the method including treating an aluminum plate with an adipic acid solution; forming an amorphous oxide-aluminum membrane on a surface of the aluminum plate through an electro-chemical treatment while the aluminum plate is treated with the adipic acid solution; and forming a crystal barrier type oxide-aluminum membrane by thermally treating the amorphous oxide-aluminum membrane.

Thermally treating the amorphous oxide-aluminum membrane may include applying a heating temperature of about 300° C. to about 600° C. and a heating time of about one hour to about twenty four hours.

In the electro-chemical treatment in the adipic acid solution, a concentration of the adipic acid solution may be about 0.5 M to about 1.5 M, a processing temperature may be about 60° C. to about 80° C., and a processing voltage may be about 100 V to about 150 V.

Between the forming the amorphous oxide-aluminum membrane and the forming the crystal barrier type oxide-aluminum membrane, the method may further include treating the aluminum plate having the amorphous oxide-aluminum membrane thereon with a boric acid solution; and increasing a thickness of the amorphous oxide-aluminum membrane through an electro-chemical treatment while the aluminum plate is treated with the boric acid solution.

In the electro-chemical treatment in the boric acid solution, a concentration of the boric acid solution may be about 0.5 M to about 2.0 M, a processing temperature may be about 60° C. to about 80° C., and a processing voltage may be about 250 V to about 500 V.

The method may further include processing the aluminum plate into a predetermined shape after the forming the crystal barrier type oxide-aluminum membrane.

The method may further include processing the aluminum plate into a predetermined shape prior to treating the aluminum plate with the adipic acid solution.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a perspective view of a case for a secondary battery and an electrode assembly in the case according to an embodiment;

FIG. 2 illustrates a sectional view of the case for a secondary battery taken along line II-II of FIG. 1;

FIG. 3 illustrates a flow chart of a method of manufacturing the case for a secondary battery according to an embodiment; and

FIG. 4 illustrates a flow chart of a method of manufacturing the case for a secondary battery according to another embodiment.

### DETAILED DESCRIPTION

Korean Patent Application No. 10-2010-0007039, filed on Jan. 26, 2010, in the Korean Intellectual Property Office, and entitled: “Case for Secondary Battery and Manufacturing Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

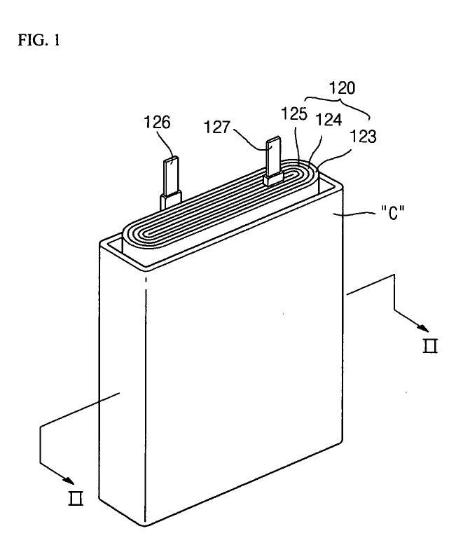

FIG. 1 illustrates a perspective view of a case for a secondary battery and an electrode assembly in the case according to an embodiment.

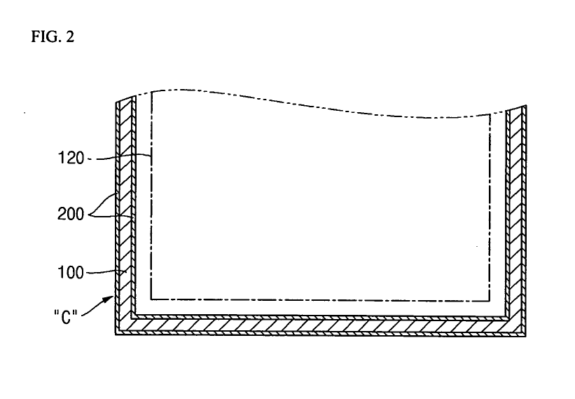

FIG. 2 illustrates a sectional view of the case for a secondary battery taken along line II-II of FIG. 1.

Referring to FIGS. 1 and 2, a case C for a secondary battery according to an embodiment may include a body 100 accommodating an electrode assembly 120 as well as a crystal barrier type oxide film 200.

As a main element for charge/discharge, the electrode assembly 120 may include a positive electrode plate 123, a negative electrode plate 125, and a separator 124. The separator 124 may be disposed between the positive electrode plate 123 and the negative electrode plate 125, which may be stacked. Hereinafter, the each element of the electrode assembly 120 will be described in detail with reference to FIG. 1.

The positive electrode plate 123 may include a positive electrode collector which is formed as a metal thin plate having superior conductivity, e.g., an aluminum foil, and a positive electrode active layer coated on both surfaces of the positive electrode collector. A positive electrode collector region (i.e., a positive electrode non-coating portion), on which a positive electrode active layer is not formed, may be disposed at both ends of the positive electrode plate 123. A positive electrode tap 126, which may be formed of, e.g., aluminum, and may protrude by a predetermined length from the electrode assembly 120, may be coupled to the positive electrode non-coating portion.

The negative electrode plate 125 may include a negative electrode collector, which is formed as a conductive metal thin plate, e.g., a copper or nickel foil, and a negative electrode active layer coated on both surfaces of the negative electrode collector. A negative electrode collector region (i.e., a negative electrode non-coating portion), on which a negative electrode active layer is not formed, may be formed at both ends of the negative electrode plate 125. A negative electrode tap 127, which may be formed of, e.g., nickel, and may protrude by a predetermined length from the electrode assembly 120, may be coupled to the negative electrode non-coating portion.

The separator 124 may prevent a short between the positive electrode plate 123 and the negative electrode plate 125. The separator 124 may be formed of a porous membrane polymer material in order for an ion to pass therethrough.

The body 100 may accommodate the electrode assembly 120, may have a plate type or shape, and may be formed of a conductive material. The plate type body 100 may be processed into, e.g., a cylinder type, a prismatic type, and/or a pouch type, according to a desired type of a battery. In an implementation, the body 100 may be an aluminum plate, which is formed of or includes aluminum or an aluminum alloy, i.e., uses aluminum as a base.

The crystal barrier type oxide film 200 may be formed on a surface of the body 200. In particular, when the body 100 is an aluminum plate (hereinafter, which is indicated by reference numeral 100 together with the body), the crystal barrier type oxide film 200 may be a crystal barrier type oxide-aluminum membrane (hereinafter, which is indicated by reference numeral 200 together with the crystal barrier type oxide film). Hereinafter, the crystal barrier type oxide-aluminum membrane 200 will be described in detail.

The crystal barrier type oxide-aluminum membrane 200 may be formed by thermally treating an amorphous oxide-aluminum membrane that is formed on the body 100, e.g., aluminum plate,. In the thermal treatment, a heating temperature may be about 300° C. to about 600° C. and a heating time may be about one hour to about twenty four hours. Maintaining the heating temperature at about 300° C. or greater may help ensure that the amorphous state is changed into the crystal state. Maintaining the heating temperature at about 600° C. or less may help ensure that energy is not unnecessarily wasted and a portion of the body 100, e.g., aluminum plate, in the crystal barrier type oxide-aluminum membrane 200 is not melted. Maintaining the heating time at about one hour or longer may help ensure that the amorphous state is sufficiently changed into a crystal state. Maintaining the heating time at about twenty four hours or less may help ensure that energy is not unnecessarily wasted where change is no longer performed, because the amorphous state has been already completely changed into the crystal state. As the amorphous state is changed into the crystal state through the thermal treatment, the crystal barrier type oxide-aluminum membrane 200 may be formed as a stable barrier structure having strong corrosion resistance. Accordingly, since a sealing process, which has been generally performed, is not separately performed, a manufacturing process may be simplified and cost can be saved.

The body 100, e.g., aluminum plate, on which the crystal barrier type oxide-aluminum membrane 200 is formed, may be used as a case for a high-capacity or high-power battery. That is, the crystal barrier type oxide-aluminum membrane 200 may be more stable, may have stronger corrosion resistance, and may have a lower swelling degree of the case C than, e.g., an amorphous oxide film or a porous type oxide film. Thus, the body 100, e.g., aluminum plate, on which the crystal barrier type oxide-aluminum membrane 200 is formed, may secure sufficient stability, even when it is used as a case for a high-capacity battery or a case for a high-power battery. In particular, the body 100, e.g., aluminum plate, on which the crystal barrier type oxide-aluminum membrane 200 is formed, may sufficiently secure stability, even when it is used as the case for a battery for a hybrid electric car or an electric car, to which impact and/or vibration from a road may be transferred.

TABLE 1

| | Insulating | Change amount of |
|---|---|---|
| | Material | swelling degree of case |
| Comparative | Amorphous porous type | Δ0.73 mm |
| Example | oxide-aluminum | |
| | membrane | |
| Embodiment | Crystal barrier type oxide- | Δ0.11 mm |
| | aluminum membrane | |

Table 1 shows a comparison table in which a result of relative comparison test in the same condition shows that a swelling degree of a case is changed according to an oxide film formed inside the case. According to the experiments, as shown in the Table 1, the case C for a secondary battery according to an embodiment in which the crystal barrier type oxide-aluminum membrane 200 is formed on the body 100 exhibited a swelling degree that is considerably reduced, relative to a case of a comparison example in which an amorphous porous type oxide-aluminum membrane was formed on a body.

The following description will be made in detail regarding an amorphous oxide-aluminum membrane before thermal treatment to form the crystal barrier type oxide-aluminum membrane 200.

The amorphous oxide-aluminum membrane may be formed on the surface of the body 100, e.g., aluminum plate, through an electro-chemical treatment. In particular, by oxidizing the surface of the body 100, e.g., aluminum plate, in a state where the body 100, e.g., aluminum plate, is treated with an adipic acid solution. In an implementation, a concentration of the adipic acid solution may be about 0.5 M to about 1.5 M, a processing temperature may be about 60° C. to about 80° C., and a processing voltage may be about 100 V to about 150 V.

Maintaining the concentration of the adipic acid solution at about 0.5 M or greater may help ensure that sufficient adipic acid is present and oxidization is sufficiently performed, thus ensuring insulating properties. Maintaining the concentration of the adipic acid solution at about 1.5 M or less may help ensure that excess adipic acid is not used, thus reducing manufacturing costs. Maintaining the processing temperature at about 60° C. or greater may help ensure that oxidization is normally performed, thereby securing insulating properties. Maintaining the processing temperature at about 80° C. or less may help ensure that oxidization is performed only as necessary, thereby reducing manufacturing costs. Maintaining the processing voltage at about 100 V or greater may help ensure that oxidization is normally performed, thereby securing insulating properties. Maintaining the processing voltage at about 150 V or less may help ensure that oxidization is performed only as necessary, thereby reducing manufacturing costs.

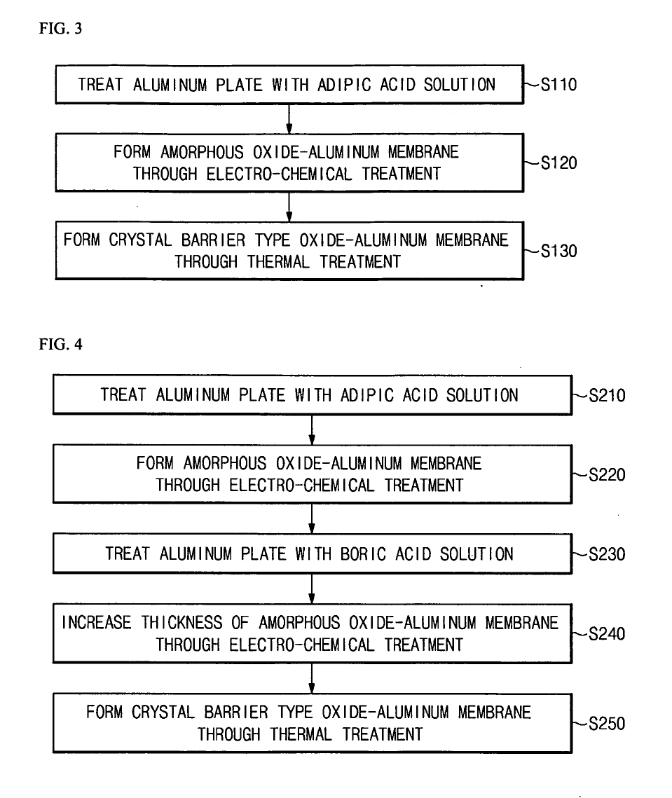

The following description will be made in detail with reference to FIG. 3 illustrating a flowchart of a method of manufacturing the above-described case for secondary battery according to an embodiment.

FIG. 3 illustrates a flow chart of a method of manufacturing the case for a secondary battery according to an embodiment.

First, the body 100, e.g., aluminum plate, may be digested in, i.e., treated with, the adipic acid solution (S110).

As the body 100, e.g., aluminum plate, is treated with the adipic acid solution, the amorphous oxide-aluminum membrane may be formed on the surface of the body 100, e.g., aluminum plate, through an electro-chemical treatment, i.e., by oxidizing the surface of the body 100, e.g., aluminum plate, (S120). In the electro-chemical treatment in the adipic acid solution, a concentration of the adipic acid solution may be about 0.5 M to about 1.5 M, a processing temperature may be about 60° C. to about 80° C., and a processing voltage may be about 100 V to about 150 V. Such values are the same as the above-described values; and thus repeated detailed description thereof will be omitted.

Then, by thermally treating the amorphous oxide-aluminum membrane that is formed by the above-described process, the crystal barrier type oxide-aluminum membrane 200 may be formed (S130). That is, the amorphous oxide-aluminum membrane may be changed to have a crystalline state and a barrier structure through thermal treatment. In the thermal treatment, a heating temperature may be about 300° C. to about 600° C. and a heating time may be about one hour to about twenty four hours. Such values are the same as the above-described values, and thus repeated detailed description thereof will be omitted.

After the crystal barrier type oxide-aluminum membrane 200 is formed, the body 100, e.g., aluminum plate, may be processed into a predetermined shape through, e.g., an impact process or a deep drawing process. In an implementation, the predetermined shape may be, e.g., a cylinder type, a prismatic type, and/a pouch type, according to the desired type of battery. In another implementation, the body 100, e.g., aluminum plate, may be processed beforehand into the predetermined shape before the body 100, e.g., aluminum plate, is treated with the adipic acid solution, instead of after the crystal barrier type oxide-aluminum membrane 200 is formed. In this case, since before the crystal barrier type oxide-aluminum membrane 200 is formed, the body 100, e.g., aluminum plate, may be easily processed in the predetermined shape without concern of damage to the crystal barrier type oxide-aluminum membrane 200, thereby saving manufacturing time.

Except for a step that may increase the thickness of an already-formed amorphous oxide-aluminum membrane by further performing an electro-chemical treatment in a boric acid solution, a case for secondary battery according to another embodiment may be the same as the case for secondary battery according to the previous embodiment. Thus, only the electro-chemical treatment in the boric acid solution will be described below.

After the amorphous oxide-aluminum membrane has been already formed with an adipic acid solution, the electro-chemical treatment in the boric acid solution may be performed in order to increase the thickness of the amorphous oxide-aluminum membrane for the purpose of securing insulating properties of the body 100, e.g., aluminum plate,. In the electro-chemical treatment in the boric acid solution, a concentration of the boric acid solution may be about 0.5 M to about 2.0 M, a processing temperature may be about 60° C. to about 80° C., and a processing voltage may be about 250 V to about 500 V.

Maintaining the concentration of the boric acid solution at about 0.5 M or greater may help ensure that sufficient boric acid is present such that oxidization may normally be performed. Maintaining the concentration of the boric acid solution at about 2.0 M or less may help ensure that excess boric acid is not used, thus reducing manufacturing costs.

Maintaining the processing temperature at about 60° C. or greater may help ensure that oxidization may normally be performed. Maintaining the processing temperature at about 80° C. or less may help ensure that oxidization is performed only as necessary, thereby reducing manufacturing costs.

Maintaining the processing voltage at about 250 V or greater may help ensure that oxidization may normally be performed. Maintaining the processing voltage at about 500 V or less may help ensure that oxidization is performed only as necessary, thereby reducing manufacturing costs.

The following description will be made in detail with reference to FIG. 4 illustrating a flowchart of a method of manufacturing the above-described case for secondary battery according to another embodiment.

FIG. 4 illustrates a flow chart of a method of manufacturing the case for a secondary battery according to another embodiment.

First, the body 100, e.g., aluminum plate, may be treated with the adipic acid solution (S210).

While the body 100, e.g., aluminum plate, is treated with the adipic acid solution, the amorphous oxide-aluminum membrane may be formed at the surface of the body 100, e.g., aluminum plate, through an electro-chemical treatment, i.e., by oxidizing the surface of the body 100, e.g., aluminum plate, (S220). In the electro-chemical treatment in the adipic acid solution, a concentration of the adipic acid solution may be about 0.5 M to about 1.5 M, a processing temperature may be about 60° C. to about 80° C., and a processing voltage may be about 100 V to about 150 V. Such values are the same as the above-described values, and thus repeated detailed description thereof will be omitted.

Then, the body 100, e.g., aluminum plate, on which the amorphous oxide-aluminum membrane is formed, may be treated with a boric acid solution (S230).

While the body 100, e.g., aluminum plate, is treated with the boric acid solution, a thickness of the amorphous oxide-aluminum membrane may increase through an electro-chemical treatment (S240). In the electro-chemical treatment in the boric acid solution, a concentration of the boric acid solution may be about 0.5 M to about 2.0 M, a processing temperature may be about 60° C. to about 80° C., and a processing voltage may be about 250 V to about 500 V. Such values are the same as the above-described values, and thus repeated detailed description thereof will be omitted.

Then, by thermally treating the amorphous oxide-aluminum membrane that is formed in this way, the crystal barrier type oxide-aluminum membrane 200 may be formed (S250). That is, the amorphous oxide-aluminum membrane may be changed to have a crystal state and a barrier structure through thermal treatment. In the thermal treatment, a heating temperature may be about 300° C. to about 600° C. and a heating time may be about one hour to about twenty four hours. Such values are the same as the above-described values, and thus repeated detailed description thereof will be omitted.

When the crystal barrier type oxide-aluminum membrane 200 is formed, the body 100, e.g., aluminum plate, may be processed into a predetermined shape through, e.g., an impact process or a deep drawing process. In an implementation, the predetermined shape may be, e.g., a cylinder type, a prismatic type, and/or a pouch type according to the desired type of battery. In another implementation, the body 100, e.g., aluminum plate, may be processed beforehand into the predetermined shape, before the body 100, e.g., aluminum plate, is treated with the adipic acid solution, instead of after the crystal barrier type oxide-aluminum membrane 200 is formed. Here, since the crystal barrier type oxide-aluminum membrane 200 may not yet be formed, the body 100, e.g., aluminum plate, may be easily processed into the predetermined shape without concern for damage to the crystal barrier type oxide-aluminum membrane 200, thereby saving a manufacturing time.

According to exemplary embodiments, the case for a secondary battery and the manufacturing method thereof may form the crystal barrier type oxide-aluminum membrane 200 on the body 100 of the case C. Thus, the crystal barrier type oxide-aluminum membrane 200 may prevent short circuits and corrosion, even if the electrode assembly 120 accommodated in the case C contacts the case C.

According to exemplary embodiments, the case for a secondary battery and the manufacturing method thereof may change the amorphous oxide-aluminum membrane into the crystal barrier type oxide-aluminum membrane 200 through thermal treatment. Thus, a manufacturing process may be simplified because a separate sealing process may not be required, thereby reducing cost.

According to exemplary embodiments, the case for a secondary battery may be relatively more stable and may have stronger corrosion resistance than a typical amorphous porous type oxide film, and may lower the swelling degree of the case.

The electrode assembly accommodated in the conductive case of an embodiment may not contact the case, even in the event of an external impact, thereby preventing a short and corrosion.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A case for a secondary battery, the case comprising:
a body formed of a conductive material, the body accommodating an electrode assembly; and
a crystal barrier type oxide film on a surface of the body.

2. The case as claimed in claim 1, wherein:
the body is an aluminum plate including aluminum or an aluminum alloy, and
the crystal barrier type oxide film is a crystal barrier type oxide-aluminum membrane.

3. The case as claimed in claim 1, wherein:
the body is an aluminum plate including aluminum or an aluminum alloy, and
the crystal barrier type oxide film is a crystal barrier type oxide-aluminum membrane which is formed by an amorphous oxide-aluminum membrane on the aluminum plate that has been subjected to a thermal treatment.

4. The case as claimed in claim 3, wherein, in the thermal treatment, a heating temperature is about 300° C. to about 600° C., and a heating time is about one hour to about twenty four hours.

5. The case as claimed in claim 3, wherein the amorphous oxide-aluminum membrane is formed on a surface of the aluminum plate through an electro-chemical treatment while the aluminum plate is treated with an adipic acid solution.

6. The case as claimed in claim 5, wherein, in the electro-chemical treatment in the adipic acid solution,
a concentration of the adipic acid solution is about 0.5 M to about 1.5 M,
a processing temperature is about 60° C. to about 80° C., and
a processing voltage is about 100 V to about 150 V.

7. The case as claimed in claim 5, wherein a thickness of the amorphous oxide-aluminum membrane is increased by an electro-chemical treatment in a boric acid solution for securing further insulating properties of the aluminum plate.

8. The case as claimed in claim 7, wherein, in the electro-chemical treatment in the boric acid solution,
a concentration of the boric acid solution is about 0.5 M to about 2.0 M,
a processing temperature is about 60° C. to about 80° C., and
a processing voltage is about 250 V to about 500 V.

9. A high-capacity or high-power battery including the case as claimed in claim 1.

10. A battery for a hybrid electric car or a case of a battery for an electric car including the case as claimed in claim 1.

11. A method of manufacturing a case for a secondary battery, the method comprising:
treating an aluminum plate with an adipic acid solution;
forming an amorphous oxide-aluminum membrane on a surface of the aluminum plate through an electro-chemical treatment while the aluminum plate is treated with the adipic acid solution; and
forming a crystal barrier type oxide-aluminum membrane by thermally treating the amorphous oxide-aluminum membrane.

12. The method as claimed in claim 11, wherein thermally treating the amorphous oxide-aluminum membrane includes applying a heating temperature of about 300° C. to about 600° C. and a heating time of about one hour to about twenty four hours.

13. The method as claimed in claim 11, wherein in the electro-chemical treatment in the adipic acid solution, a concentration of the adipic acid solution is about 0.5 M to about 1.5 M, a processing temperature is about 60° C. to about 80° C., and a processing voltage is about 100 V to about 150 V.

14. The method as claimed in claim 11, wherein, between the forming the amorphous oxide-aluminum membrane and the forming the crystal barrier type oxide-aluminum membrane, the method further comprises:
treating the aluminum plate having the amorphous oxide-aluminum membrane thereon with a boric acid solution; and
increasing a thickness of the amorphous oxide-aluminum membrane through an electro-chemical treatment while the aluminum plate is treated with the boric acid solution.

15. The method as claimed in claim 14, wherein, in the electro-chemical treatment in the boric acid solution, a concentration of the boric acid solution is about 0.5 M to about 2.0 M, a processing temperature is about 60° C. to about 80° C., and a processing voltage is about 250 V to about 500 V.

16. The method as claimed in claim 11, further comprising processing the aluminum plate into a predetermined shape after the forming the crystal barrier type oxide-aluminum membrane.

17. The method as claimed in claim 11, further comprising processing the aluminum plate into a predetermined shape prior to treating the aluminum plate with the adipic acid solution.
